(19) United States
(12) Patent Application Publication
(10) Pub. No.: US 2026/0329325 A1
(43) Pub. Date: Oct. 22, 2026

(54) OPERATION CONTROL DEVICE, PROCESSING DEVICE, AND NON-TRANSITORY COMPUTER-READABLE MEDIUM

(71) Applicants: KABUSHIKI KAISHA TOKAI RIKA DENKI SEISAKUSHO, Aichi (JP); TOYOTA JIDOSHA KABUSHIKI KAISHA, Aichi-ken (JP)

(72) Inventors: Hideaki TAKEDA, Aichi (JP); Kana KATASHIMA, Aichi (JP); Takeshi OHNISHI, Aichi (JP); Junichi FUKUI, Aichi (JP); Yasutaka MATSUDA, Aichi (JP); Yusuke KUMAKIRI, Aichi (JP); Masahiro INOUE, Aichi (JP); Takuma FUKUDA, Aichi (JP); Yoshiyuki MURAMATSU, Aichi-ken (JP)

(73) Assignees: KABUSHIKI KAISHA TOKAI RIKA DENKI SEISAKUSHO, Aichi (JP); TOYOTA JIDOSHA KABUSHIKI KAISHA, Aichi-ken (JP)

(21) Appl. No.: 19/653,621

(22) Filed: Apr. 21, 2026

(30) Foreign Application Priority Data
Apr. 22, 2025 (JP) 2025-070168

(51) Int. Cl. G05G 1/10; B60K 35/10

(52) U.S. Cl. CPC G05G 1/10; B60K 35/10; B60K 2360/126

(57) ABSTRACT

An operation control device includes a shaft and a grip. The shaft is rotatable about an axis to be associated with a first operation. The grip is gripped by a user's hand to turn about the axis. A movable member includes first and second areas associated with second and third operations, respectively. The second area is disposed between the grip and the first area when viewed from a direction along the axis. A processing device validates the second and third operations in a case where the movable member is displaced under a condition that contact of a user's finger with respect to the first and second areas is detected, respectively. The processing device validates the third operation in a case where the movable member is displaced under a condition that contact of a user's finger is not detected with respect to any of the first and second areas.

### CROSS-REFERENCE TO RELATED APPLICATION

The present application is based on Japanese Patent Application No. 2025-070168 filed on Apr. 22, 2025, the entire contents of which are incorporated herein by reference.

### BACKGROUND

The presently disclosed subject matter relates to an operation control device equipped with a processing device adapted to control an operation of a controlled device. The presently disclosed subject matter also relates to a processing device adapted to be equipped with the operation control device. The presently disclosed subject matter also relates to a non-transitory computer-readable medium having stored a computer program adapted to be executed by the processing device.

Japanese Patent Publication No. 2024-108625A discloses a power window device as an exemplary operation control device that is adapted to be installed in a vehicle as an exemplary mobility. The power window device includes a movable member that allows mechanical displacement. The movable member includes multiple operation accepting areas. The multiple operation accepting areas are associated with different windows. Each of the multiple operation accepting areas is adapted to detect change in electrostatic capacitance caused by contact of a driver's finger. When the mechanical displacement of the movable member is performed under a condition that change in the electrostatic capacitance exceeding a threshold value is detected in a particular operation accepting area, an opening/closing operation of a window associated with the operation accepting area is executed.

### SUMMARY

There is a need for improving the convenience of an operation control device equipped with a movable member adapted to control multiple operations of a controlled device.

An illustrative aspect of the presently disclosed subject matter may provide an operation control device, comprising:
a shaft configured to allow a rotation about a rotation axis, the rotation being associated with a first controlled operation;
a grip adapted to be turned about the rotation axis along a turning path, and t be gripped by a hand of a user;
a movable member; and
a processing device,
wherein the movable member includes:
   a first operation accepting area associated with a second controlled operation; and
   a second operation accepting area disposed between the grip and the fir operation accepting area when viewed from a first direction along the rotation axis, and associated with a third controlled operation; and
wherein the processing device is configured to:
   validate selection of the second controlled operation in a case where the movable member is displaced under a condition that contact of a finger of the user with respect to the first operation accepting area is detected;
   validate selection of the third controlled operation in a case where the movable member is displaced under a condition that contact of a finger of the user with respect to the second operation accepting area is detected; and
   validate selection of the third controlled operation in a case where the movable member is displaced under a condition that contact of a finger of the user is not detected with respect to any of the first operation accepting area and the second operation accepting area.

An illustrative aspect of the presently disclosed subject matter may provide a processing device adapted to be equipped with an operation control device that includes: a shaft configured to allow a rotation about a rotation axis, the rotation being associated with a first controlled operation; a grip adapted to be turned about the rotation axis along a turning path, and to be gripped by a hand of a user; and a movable member, the processing device comprising:
an interface configured to receive a signal corresponding to displacement of the movable member; and
a processor,
wherein the movable member includes:
   a first operation accepting area associated with a second controlled operation; and
   a second operation accepting area disposed between the grip and the fir operation accepting area when viewed from a first direction along the rotation axis, and associated with a third controlled operation; and
wherein the processing device is configured to:
   validate selection of the second controlled operation in a case where the movable member is displaced under a condition that contact of a finger of the user with respect to the first operation accepting area is detected;
   validate selection of the third controlled operation in a case where the movable member is displaced under a condition that contact of a finger of the user with respect to the second operation accepting area is detected; and
   validate selection of the third controlled operation in a case where the movable member is displaced under a condition that contact of a finger of the user is not detected with respect to any of the first operation accepting area and the second operation accepting area.

An illustrative aspect of the presently disclosed subject matter may provide a non-transitory computer-readable medium having stored a computer program adapted to be executed by a processing device that is adapted to be equipped with an operation control device that includes: a shaft configured to allow a rotation about a rotation axis, the rotation being associated with a first controlled operation; a grip adapted to be turned about the rotation axis along a turning path, and to be gripped by a hand of a user; and a movable member,
wherein the movable member includes:
   a first operation accepting area associated with a second controlled operation; and
   a second operation accepting area disposed between the grip and the fir operation accepting area when viewed from a first direction along the rotation axis, and associated with a third controlled operation; and
wherein the computer program is configured to, when executed, cause the processing device to:
   validate selection of the second controlled operation in a case where the movable member is displaced under a condition that contact of a finger of the user with respect to the first operation accepting area is detected;
   validate selection of the third controlled operation in a case where the movable member is displaced under a condition that contact of a finger of the user with respect to the second operation accepting area is detected; and
   validate selection of the third controlled operation in a case where the movable member is displaced under a condition that contact of a finger of the user is not detected with respect to any of the first operation accepting area and the second operation accepting area.

The second operation accepting area located farther from the shaft of the operation control device is disposed closer to the base of the user's finger. Accordingly, when the movable member is displaced under the condition that the contact of the finger is not detected in either the first operation accepting area or the second operation accepting area, it is highly likely that the movable member is actuated under a condition that the finger fails to reach the second operation accepting area although the user intends to select the operation of the controlled device associated with the second operation accepting area.

According to the configuration of each of the illustrative aspects, since the operation for selecting the controlled device associated with the second operation accepting area is validated under such a situation, it is possible to suppress occurrence of a situation in which the controlled device is not operated in response to the actuation of the movable member against the user's intention. Accordingly, it is possible to improve the convenience of the operation control device equipped with the movable member adapted to control multiple operations of the controlled device.

### DESCRIPTION OF THE DRAWINGS

FIG. 1 illustrates a steering device according to an exemplary embodiment.

FIG. 2 illustrates an appearance of an input device adapted to be equipped with the steering device of FIG. 1.

FIG. 3 illustrates a cross-section along the line III-III in FIG. 2 when viewed from an arrowed direction.

FIG. 4 illustrates an exemplary flow of processing executed by a processing device of FIG. 3.

FIG. 5 is a drawing for explaining operations of the processing device of FIG. 3.

FIG. 6 is a drawing for explaining operations of the processing device of FIG. 3.

FIG. 7 is a drawing for explaining operations of the processing device of FIG. 3.

FIG. 8 is a drawing for explaining operations of the processing device of FIG. 3.

FIG. 9 is a drawing for explaining operations of the processing device of FIG. 3.

FIG. 10 is a drawing for explaining operations of the processing device of FIG. 3.

### DESCRIPTION OF EMBODIMENTS

Exemplary embodiments will be described in detail below with reference to the accompanying drawings. In the drawings used in the following descriptions, the scale thereof is changed as required in order to make each element to a recognizable size.

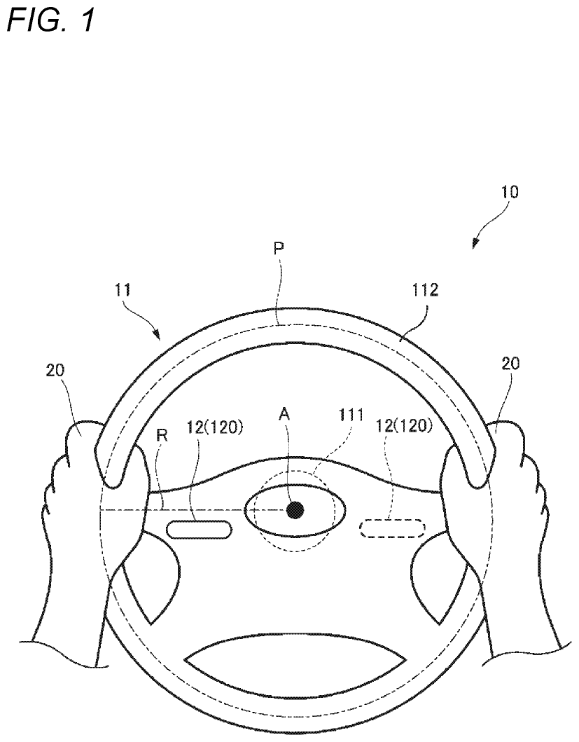

FIG. 1 illustrates an appearance of a steering device 10 according to an exemplary embodiment. The steering device 10 is a device adapted to be disposed in a cabin of a vehicle to cause the vehicle to perform an operation of changing a traveling direction. The steering device 10 is an exemplary operation control device. The operation of changing the traveling direction is an exemplary first controlled operation. The vehicle is an exemplary mobility.

The steering device 10 includes a steering member 11. The steering member 11 includes a shaft 111 and a grip 112. The shaft 111 is adapted to be rotated about a rotation axis A. The grip 112 is adapted to be gripped by a driver's hand 20. The driver is an exemplary user. The grip 112 is adapted to be turned along a turning path P about the rotation axis A. As the grip 112 is turned by the driver's hand 20, the shaft 111 rotates in the same direction. The rotation direction is associated with the traveling direction of the vehicle to be changed.

The steering device 10 includes an input device 12. The input device 12 is disposed between the shaft 111 and the grip 112 when viewed from a direction along the rotation axis A.

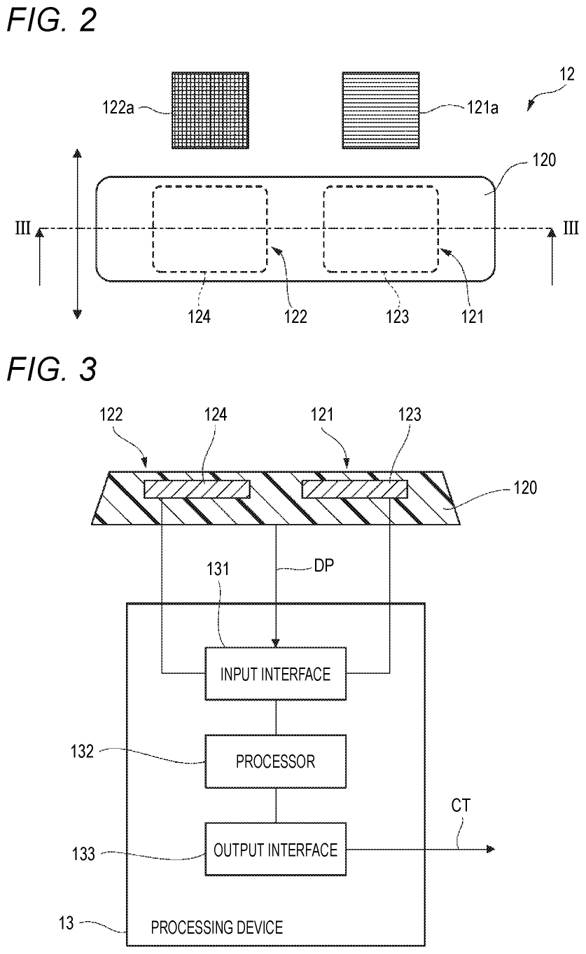

FIG. 2 illustrates an appearance of the input device 12 when viewed from the direction along the rotation axis A. The input device 12 includes a movable member 120. The movable member 120 is disposed at a position where a finger of a driver's hand holding the grip 112 of the steering member 11 can reach.

The movable member 120 is allowed to be displaced in a direction along an up-down direction of the vehicle by the finger. The movable member 120 is configured to return to the initial position when the actuation force by the finger is canceled. The allowed displacement direction from the initial position may be at least one of a direction corresponding to an upward direction of the vehicle and a direction corresponding to a downward direction of the vehicle.

The movable member 120 includes a first operation accepting area 121 and a second operation accepting area 122. The first operation accepting area 121 is associated with an operation of a controlled device installed in the vehicle. The second operation accepting area 122 is associated with another operation of the controlled device installed in the vehicle.

Examples of the controlled device include a device for adjusting a position of equipment installed in a vehicle (a seat, a steering device, a window, a rearview mirror, and the like), a lighting device, an air conditioner, and an audio-visual device. The operation associated with the first operation accepting area 121 and the operation associated with the second operation accepting area 122 may be different operations of an identical controlled device, or operations of different controlled devices. The operation associated with the first operation accepting area 121 is an exemplary second controlled operation. The operation associated with the second operation accepting area 122 is an exemplary third controlled operation.

The first operation accepting area 121 and the second operation accepting area 122 are arranged to be side by side along a turning radius R of the grip 112 of the steering member 11 illustrated in FIG. 1 when viewed from the direction along the rotation axis A. The first operation accepting area 121 is disposed between the shaft 111 and the second operation accepting area 122 when viewed from the direction along the rotation axis A.

In the vicinity of the first operation accepting area 121, an icon 121a is provided so that the driver can recognize the associated operation of the controlled device. The icon 121a is configured with at least one of characters, numerals, symbols, graphics, pictures, and colors.

Similarly, an icon 122a is provided in the vicinity of the second operation accepting area 122 so that the driver can recognize the associated operation of the controlled device. The icon 122a is configured to be distinguishable from the icon 121a using at least one of characters, numerals, symbols, graphics, pictures, and colors.

FIG. 3 illustrates a cross-section along the line III-III in FIG. 2 when viewed from an arrowed direction. The input device 12 includes a first electrode 123 and a second electrode 124.

The first electrode 123 is incorporated in the movable member 120. The first electrode 123 is provided for detecting a change in electrostatic capacitance caused by contact of a driver's finger 21 with respect to the first operation accepting area 121.

The second electrode 124 is also incorporated in the movable member 120. The second electrode 124 is provided for detecting a change in electrostatic capacitance caused by contact of a driver's finger 21 with respect to the second operation accepting area 122.

Accordingly, the first electrode 123 and the second electrode 124 are arranged side by side along the turning radius R of the grip 112 of the steering member 11 illustrated in FIG. 1 when viewed from the direction along the rotation axis A. The first electrode 123 is disposed between the shaft 111 and the second electrode 124 when viewed from the direction along the rotation axis A.

The steering device 10 includes a processing device 13. The processing device 13 includes an input interface 131. The input interface 131 is a hardware interface electrically connected to the first electrode 123 and the second electrode 124. Change in electrostatic capacitance between the first electrode 123 and the second electrode 124 is reflected to an electrical state of the input interface 131.

The input interface 131 is configured to receive a displacement signal DP corresponding to the displacement of the movable member 120. The displacement signal DP is outputted from a sensor (not illustrated) for detecting the displacement of the movable member 120. The displacement of the movable member 120 can be detected by a well-known technique such as mechanical, optical, or magnetic.

The displacement signal DP may be an analog signal or a digital signal according to the specification of the above-described sensor. Similarly, the electrical state corresponding to the change in the electrostatic capacitance between the first electrode 123 and the second electrode 124 may be associated with an analog signal or a digital signal. In a case where an analog signal is used, the input interface 131 is provided with an appropriate conversion circuit including an A/D converter.

The processing device 13 includes a processor 132 and an output interface 133. The processor 132 outputs a control signal CT for controlling an operation of the controlled device from the output interface 133 in accordance with the displacement of the movable member 120 and the electrical states of each of the first electrode 123 and the second electrode 124. The control signal CT may be an analog signal or a digital signal according to the specification of the controlled device.

The output interface 133 is a hardware interface adapted to output a control signal CT. In a case where the control signal CT is an analog signal, the output interface 133 is provided with an appropriate conversion circuit including a D/A converter.

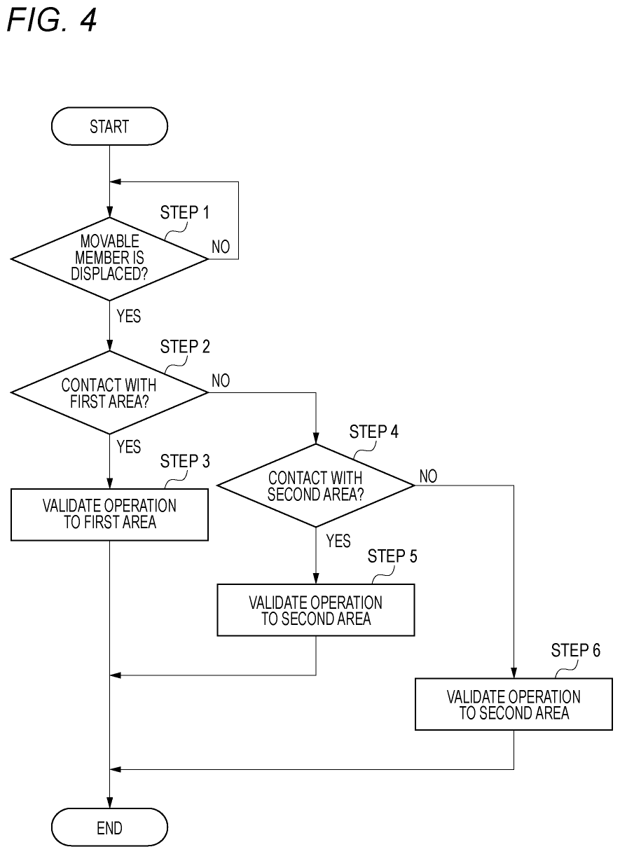

FIG. 4 illustrates a flow of processing executed by the processor 132 of the processing device 13 configured as described above. It should be noted that an order of which each processing element is executed is merely by way of illustration. The order can be appropriately changed.

First, the processor 132 determines whether the movable member 120 is displaced by a driver's operation (STEP1). Specifically, it is determined whether the displacement signal DP corresponding to the displacement is received by the input interface 131. The processing is repeated until it is determined that the movable member 120 is displaced (NO in STEP1).

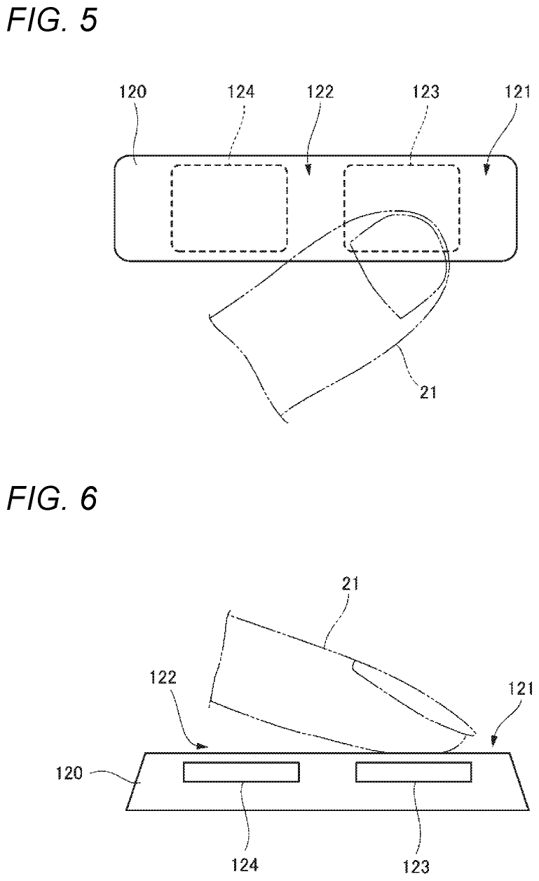

Subsequently, in accordance with the electrical state of the first electrode 123, the processor 132 determines whether the finger 21 of the driver contacts the first operation accepting area 121 of the movable member 120 as illustrated in FIGS. 5 and 6 (STEP2).

In response to the determination that the finger 21 of the driver contacts the first operation accepting area 121 of the movable member 120 (YES in STEP2), the processor 132 validates the operation with respect to the first operation accepting area 121, so that a control signal CT for causing the controlled device to perform an operation associated with that operation is outputted from the output interface 133 (STEP3).

In other words, in response to the displacement of the movable member 120 under the condition that the contact of the finger 21 with respect to the first operation accepting area 121 is detected, the processing device 13 validates the operation for selecting the controlled device associated with the first operation accepting area 121.

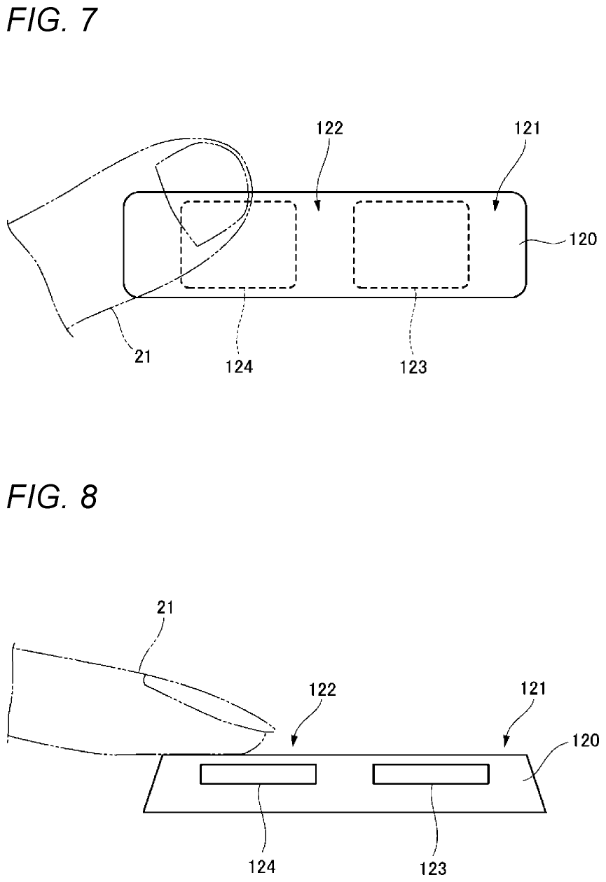

In response to the determination that the finger 21 of the driver does not contact the first operation accepting area 121 of the movable member 120 (NO in STEP2), the processor 132 determines whether the finger 21 of the driver contacts the second operation accepting area 122 of the movable member 120 as illustrated in FIGS. 7 and 8, in accordance with the electrical state of the second electrode 124 (STEP4).

In response to the determination that the finger 21 of the driver contacts the second operation accepting area 122 of the movable member 120 (YES in STEP4), the processor 132 validates the operation with respect to the second operation accepting area 122, so that a control signal CT for causing the controlled device to perform an operation associated with that operation is outputted from the output interface 133 (STEP5).

In other words, in response to the displacement of the movable member 120 under the condition that the contact of the finger 21 with respect to the second operation accepting area 122 is detected, the processing device 13 validates the operation for selecting the controlled device associated with the second operation accepting area 122.

In response to the determination that the finger 21 of the driver does not contact the second operation accepting area 122 of the movable member 120 (NO in STEP4), the processor 132 validates the operation with respect to the second operation accepting area 122, so that a control signal CT for causing the controlled device to perform an operation associated with that operation from the output interface 133 (STEP6).

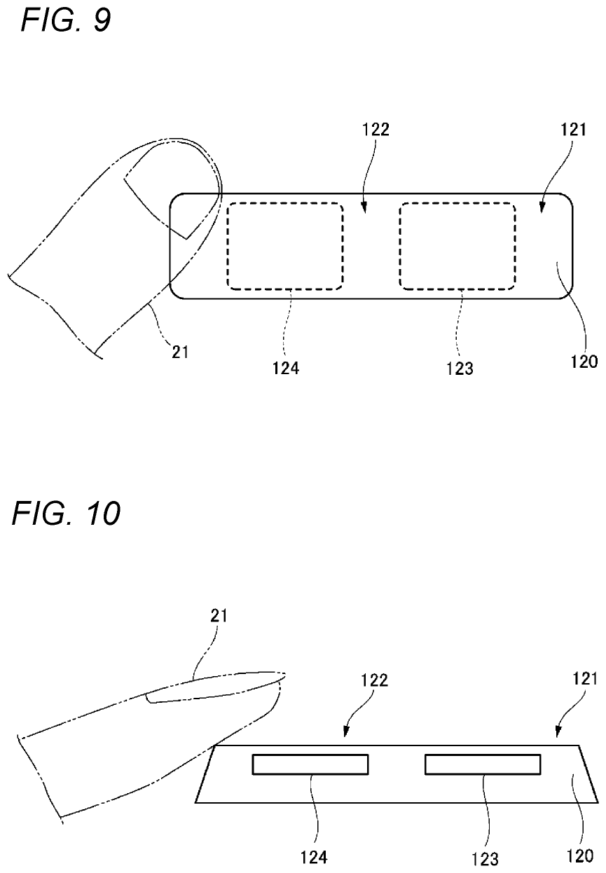

As illustrated in FIGS. 9 and 10, the movable member 120 may be actuated under a condition that the finger 21 of the driver fails to reach the second operation accepting area 122. In response to the displacement of the movable member 120 under the condition that the driver's finger 21 does not contact any of the first operation accepting area 121 and the second operation accepting area 122 as described above, the processing device 13 validates the operation for selecting the controlled device associated with the second operation accepting area 122.

The second operation accepting area 122 located farther from the shaft 111 of the steering member 11 is disposed closer to a base of the driver's finger. Accordingly, when the movable member 120 is displaced under the condition that the contact of the finger 21 is not detected in either the first operation accepting area 121 or the second operation accepting area 122, it is highly likely that the movable member 120 is actuated under a condition that the finger 21 fails to reach the second operation accepting area 122 although the driver intends to select the operation of the controlled device associated with the second operation accepting area 122.

According to the configuration of the present exemplary embodiment, since the operation for selecting the controlled device associated with the second operation accepting area 122 is validated under such a situation, it is possible to suppress occurrence of a situation in which the controlled device is not operated in response to the actuation of the movable member 120 against the driver's intention. Accordingly, it is possible to improve the convenience of the steering device 10 equipped with the movable member 120 adapted to control multiple operations of the controlled device.

The processor 132 capable of executing the processing as described above can be implemented by at least one exclusive integrated circuit equipped with a storage element in which a computer program for executing the processing is pre-installed. Examples of the exclusive integrated circuit include a microcontroller, an ASIC, and an FPGA. In this case, the memory element is an exemplary non-transitory computer-readable medium having stored a computer program.

Alternatively, the processor 132 may be implemented by at least one versatile microprocessor configured to cooperate with at least one versatile memory. Examples of the versatile microprocessor include a CPU, an MPU, and a GPU. Examples of the versatile memory include a ROM and a RAM. In this case, a computer program for realizing the functions may be stored in the ROM. The ROM is an exemplary non-transitory computer-readable medium having stored a computer program. The versatile microprocessor specifies at least a part of the program stored in the ROM, loads the program on the RAM, and executes the processing described above in cooperation with the RAM. The computer program may be pre-installed in a versatile memory, or may be downloaded from an external server device via a communication network and then installed in the versatile memory. In this case, the external server device is an exemplary non-transitory computer-readable medium having stored a computer program.

The processor 132 may be implemented by a combination of the versatile microprocessor and the exclusive integrated circuit.

The foregoing description of various configurations is provided merely by way of illustration to facilitate understanding of the presently disclosed subject matter. Each of the above exemplary configurations may be appropriately modified or combined with another exemplary configuration within the scope of the presently disclosed subject matter.

In the above exemplary embodiment, the input device 12 is disposed at a position capable of being operated with a finger of a left hand of the driver. Additionally or alternatively, as illustrated in FIG. 1, the input device 12 may be disposed at a position capable of being operated with a finger of a right hand of the driver. In this case, the first operation accepting area 121 is disposed in a position in the left of the second operation accepting area 122.

In the above exemplary embodiment, the contact of the driver's finger 21 with respect to the first operation accepting area 121 and the second operation accepting area 122 is detected based on change in the electrostatic capacitance between the first electrode 123 and the second electrode 124. However, the contact of the driver's finger 21 with respect to the first operation accepting area 121 and the second operation accepting area 122 may be detected with a pressure-sensitive sensor or an optical sensor.

In the above exemplary embodiment, the movable member 120 in the form of a toggle switch is disposed between the shaft 111 and the grip 112 when viewed from the direction along the rotation axis A of the steering member 11. However, as long as the first operation accepting area 121 and the second operation accepting area 122 are provided, the appearance and the arrangement of the movable member 120 can be appropriately determined.

For example, the movable member 120 may be provided as a lever switch disposed behind the grip 112 of the steering member 11 and extending in a direction along the turning radius R of the grip 112. In this case, the displacement direction of the movable member 120 is along the turning path P of the grip 112. Alternatively, the movable member 120 may be a paddle switch disposed behind the grip 112 of the steering member 11 and allowing displacement in a direction along a front-rear direction of the vehicle.

The shape of the steering member 11 need not be annular. As long as the turning radius R about the rotation axis A and the turning path P of the grip 112 can be defined, the shape of the steering member 11 may be arbitrary. The grip 112 may have a shape in which a portion gripped by a left hand of the driver and a portion gripped by a right hand of the driver are independent from each other.

The input device 12 may be equipped with a steering device for changing the traveling direction of a mobility other than the vehicle. Examples of another mobility include a railway, a ship, and an aircraft. The function other than the direction indicating function and the controlled operation associated with the function may be appropriately determined according to the specification of the mobility.

The input device 12 need not be installed in a steering device of a mobility. For example, a controller equipped with the shaft 111 and the grip 112 can be used to control movements of an object to be displayed on a display of a simulator device for training control of a mobility, or a display of a game device in an amusement facility. The first operation accepting area 121 and the second operation accepting area 122 can be used by a user to select one of multiple functions adapted to be executed by the object, and to execute an operation associated with the selected function. In this case, the controller is an exemplary operation control device. The movement of the object is an exemplary first controlled operation. The operation associated with each function adapted to be executed by the object is an exemplary second controlled operation.

1. An operation control device, comprising:
a shaft configured to allow a rotation about a rotation axis, the rotation being associated with a first controlled operation;
a grip adapted to be turned about the rotation axis along a turning path, and t be gripped by a hand of a user;
a movable member; and
a processing device,
wherein the movable member includes:
a first operation accepting area associated with a second controlled operation; and
a second operation accepting area disposed between the grip and the fir operation accepting area when viewed from a first direction along the rotation axis, and associated with a third controlled operation; and
wherein the processing device is configured to:
validate selection of the second controlled operation in a case where the movable member is displaced under a condition that contact of a finger of the user with respect to the first operation accepting area is detected;
validate selection of the third controlled operation in a case where the movable member is displaced under a condition that contact of a finger of the user with respect to the second operation accepting area is detected; and
validate selection of the third controlled operation in a case where the movable member is displaced under a condition that contact of a finger of the user is not detected with respect to any of the first operation accepting area and the second operation accepting area.

2. The operation control device according to claim 1,
wherein the movable member is disposed between the grip and the shaft when viewed from the direction along the rotation axis.

3. The operation control device according to claim 1,
wherein the first controlled operation is changing a travel direction of a mobility; and
wherein the second controlled operation and the third controlled operation are different operations of at least one controlled device installed in the mobility.

4. A processing device adapted to be equipped with an operation control device t includes: a shaft configured to allow a rotation about a rotation axis, the rotation being associated with a first controlled operation; a grip adapted to be turned about the rotation axis along a turning path, and to be gripped by a hand of a user; and a movable member, the processing device comprising:
an interface configured to receive a signal corresponding to displacement of the movable member; and
a processor,
wherein the movable member includes:
a first operation accepting area associated with a second controlled operation; and
a second operation accepting area disposed between the grip and the fir operation accepting area when viewed from a first direction along the rotation axis, and associated with a third controlled operation; and
wherein the processing device is configured to:
validate selection of the second controlled operation in a case where the movable member is displaced under a condition that contact of a finger of the user with respect to the first operation accepting area is detected;
validate selection of the third controlled operation in a case where the movable member is displaced under a condition that contact of a finger of the user with respect to the second operation accepting area is detected; and
validate selection of the third controlled operation in a case where the movable member is displaced under a condition that contact of a finger of the user is not detected with respect to any of the first operation accepting area and the second operation accepting area.

5. A non-transitory computer-readable medium having stored a computer program adapted to be executed by a processing device that is adapted to be equipped with an operation control device that includes: a shaft configured to allow a rotation about a rotation axis, the rotation being associated with a first controlled operation; a grip adapted to be turned about the rotation axis along a turning path, and to be gripped by a hand of a user; and a movable member,
wherein the movable member includes:
a first operation accepting area associated with a second controlled operation; and
a second operation accepting area disposed between the grip and the fir operation accepting area when viewed from a first direction along the rotation axis, and associated with a third controlled operation; and
wherein the computer program is configured to, when executed, cause the processing device to:
validate selection of the second controlled operation in a case where the movable member is displaced under a condition that contact of a finger of the user with respect to the first operation accepting area is detected;
validate selection of the third controlled operation in a case where the movable member is displaced under a condition that contact of a finger of the user with respect to the second operation accepting area is detected; and
validate selection of the third controlled operation in a case where the movable member is displaced under a condition that contact of a finger of the user is not detected with respect to any of the first operation accepting area and the second operation accepting area.
